(19) United States
(12) Patent Application Publication
(10) Pub. No.: US 2012/0280847 A1
(43) Pub. Date: Nov. 8, 2012

(54) SYSTEM FOR DETECTING AN INTRUSION AND METHOD

(75) Inventor: Yaacov FRUCHT, Akko (IL)

(73) Assignee: FRUCHT SYSTEMS, TECHNOLOGIES AND BUSINESS DEVELOPMENT, Akko (IL)

(21) Appl. No.: 13/463,028

(22) Filed: May 3, 2012

(30) Foreign Application Priority Data
May 3, 2011 (IL) 212674

(51) Int. Cl. H01Q 15/00; G01S 13/04

(52) U.S. Cl. 342/7

(57) ABSTRACT

A system and a method for detecting an intrusion in an area by disposing a plurality of corner reflectors therein, interrogating and receiving successive response signals therefrom, and operating a control unit, coupled to a radar, the control unit being operative to compare and detect a change in returned signals for each one interrogation. A change to the returned signals, say above a certain threshold of change, may be proof that an intrusion had taken place.

### TECHNICAL FIELD

The embodiments of the present invention relate to the surveillance of an area, and in particular, to the detection of an intrusion in that area.

### TECHNICAL PROBLEM

The proprietor or an authority in charge of an area of terrain may want to acquire information about any intrusion that takes place or has taken place therein. The area of terrain or area may be placed under surveillance. Examples of intrusion include events such as animals entering for grazing, people walking or vehicles passing through the area under surveillance. The area might be restricted due to sanitary reasons, such as is the case with an infected area, or due to safety issues, i.e. danger of collapse of a structure for example, for security reasons, or for any other reason.

### SOLUTION TO PROBLEM

One way of detecting an intrusion in an area is to relate the intrusion to a change in a feature of the area. Any disturbance to the feature, say above a certain predetermined threshold of change may be proof that an intrusion has taken place. It may be possible therefore, to create an initial feature of the area and inspect that initial feature of the are area from time to time to detect whether the feature has changed.

For example, one may disperse a plurality of responsive objects onto an area of terrain to form a pattern, interrogate the area at successive intervals of time and receive returned signals from the responsive objects. The pattern of responsive objects constitutes the feature referred to hereinabove. The returned signals from the responsive objects may be observed, recorded, and saved for comparison with the signals returned by the initial feature. However, other sets of returned signals, different from the initial feature, may be selected as a reference feature for comparison instead of the initial feature.

An intrusion may be caused by one of or by a combination of animals, people and objects that have displaced or obscured, totally or partially, portions of the interrogated pattern. Should such a disturbance have occurred, then a signal such as an alarm signal might be provided to alert an interested party.

### ADVANTAGEOUS EFFECTS OF INVENTION

The embodiments described hereinbelow provide simple and inexpensive means for the automatic detection of intrusion into an area. Intrusions may be detected to have happened in the past or may be monitored in real time. The detection system may be coupled together to form a link or chain of areas under surveillance. Such a link may be configured as a linear barrier or as a periphery enclosing a wide surface of terrain, which is larger than the area covered by one surveillance system.

### SUMMARY OF INVENTION

The present invention provides a system and a method for interrogating and receiving successive response signals from the area and comparing the returned signals for each one interrogation to detect a change therebetween, which change is indicative of an intrusion.

The system includes a plurality of corner reflectors dispersed in a pattern in the area under surveillance and a radar system, or radar for short, configured to interrogate and receive returned signals from the area, including returned signals from the pattern of corner reflectors. Coupled to the radar, the system also includes a control unit having a processor configured to compare and detect changes in the returned signals.

Activities may include trespassing by animals, people and vehicles alone and in combination. Any disturbance, including such trespassing causes a change in returned signals from the area. Should the change in the returned signals be above a predetermined threshold, then the system may trigger an alarm signal.

To provide verification and report about the intrusion, a camera and a directional microphone may be coupled to and made operative in conjunction with the radar. When the intrusion is detected, the control unit triggers the camera and/or the directional microphone into operation to derive images of the area and/or audio signals therefrom, respectively.

The embodiments of the present invention disclose a system and a method for detecting an intrusion in an area, the system comprising a plurality of corner reflectors disposed in the area, a radar system for interrogating and receiving returned signals from the plurality of corner reflectors and receiving returned signals therefrom, and a control unit coupled to the radar system for controlling the system, the system being characterized by comprising the plurality of corner reflectors being distributed in a pattern, the radar being configured for interrogating the pattern at successively timed apart intervals, and the control unit being configured for comparing successively returned signals to signals returned from a reference interrogation to detect a change therebetween that exceeds a predetermined threshold, which change is indicative of an intrusion.

It is an object of the present invention to provide a system and a method for detecting an intrusion into an area (10). The system may comprise a plurality of corner reflectors disposed in the area and distributed in a pattern, and a radar configured for interrogating the pattern of corner reflectors at successively timed apart intervals and for receiving returned signals therefrom. The system may also comprise a control unit coupled to the radar for controlling the system and configured for comparing successively returned signals with signals returned from a reference interrogation to detect a change therebetween that exceeds a predetermined threshold, the change being indicative of an intrusion.

The plurality of corner reflectors may be disposed in a pattern of terrain range gates and may be distributed alone and in combination as selected from a group including a random pattern distribution and an ordered pattern distribution.

It is also an object of the present invention to provide at least one of both a camera and a directional microphone coupled to the control unit, and configured to derive, respectively, at least an image and at least an audio signal from the area, when an intrusion is detected. The images derived by the camera may be selected alone and in combination from a group including daylight images and nighttime images, and the nighttime images include infrared images.

It is another object of the present invention to provide the plurality of corner reflectors disposed in a configuration selected alone and in combination from a group including disposition at ground level, disposition at a same height above ground level, and disposition at different heights above ground level.

It is yet an object of the present invention to provide a control unit that is configured to derive a height of a highest above ground level obscured corner reflector, which height is indicative of a minimum height of the intrusion.

It is still an object of the present invention to provide for the change in the returned signal to occur when at least one corner reflector is detected in a disposition selected alone and in combination from a group including an obscured corner reflector and a displaced corner reflector.

Furthermore, the plurality of corner reflectors may be disposed in the area by means selected from a group including ground based means, seagoing means, and airborne means. The plurality of corner reflectors may be selected alone and in combination from a group including camouflaged corner reflectors and corner reflectors that are packaged to enhance prevention of detection by visual surveillance of the area.

It is yet another object of the present invention to provide a radar that may be disposed at a height above ground level as well as being disposed remote from the control unit.

It is one object of the present invention to provide a method for detecting an intrusion in an area by using the following steps: Distributing a plurality of corner reflectors in the area in a pattern, including a pattern of terrain range gates,

operating a radar to interrogate the plurality of corner reflectors by emitting and receiving returned signals therefrom at successively timed apart intervals, and

providing a control unit (40) coupled to the radar and operating the control unit to compare successively returned signals received by the radar from the pattern to a reference returned signal, to detect a change therebetween that exceeds a predetermined threshold, the change being indicative of an intrusion.

The method also provides for deriving a radar cross section and a voltage from returned signals received from each one of the terrain range gates.

It is a further object of the present invention to provide steps for detecting a change in the returned signals in response to at least one of the corner reflectors being detected in a disposition selected alone and in combination from a group including an obscured corner reflector and a displaced corner reflector.

It is yet a further object of the present invention to provide steps for distributing at least one corner reflector at a specific height above ground level, and for detecting a change in the returned signals in response to the at least one corner reflector being obscured by an intrusion, the specific height being indicative of a minimum height of the intrusion.

The method also includes steps for triggering an alarm signal upon detection of an intrusion.

### BRIEF DESCRIPTION OF DRAWINGS

Non-limiting embodiments of the invention will be described with reference to the following description of exemplary embodiments, in conjunction with the figures, in which:

FIG. 1 is schematic view of an area of terrain interrogated by a radar, in conjunction with a camera and a directional microphone coupled thereto,

FIG. 2 is a block diagram teaching the process of operation of the interrogator,

FIG. 3 presents a row of symbolic shapes, for example, four such shapes, shown as areas that are separated away from each other, but are interrogated by a same number of interrogators,

FIG. 4 depicts a row of overlapping symbolic shapes forming a chain of links, such as four, for example, and

FIG. 5 shows a protected area encircled by a chain of overlapping symbolic shapes 10.

### DESCRIPTION OF EMBODIMENTS

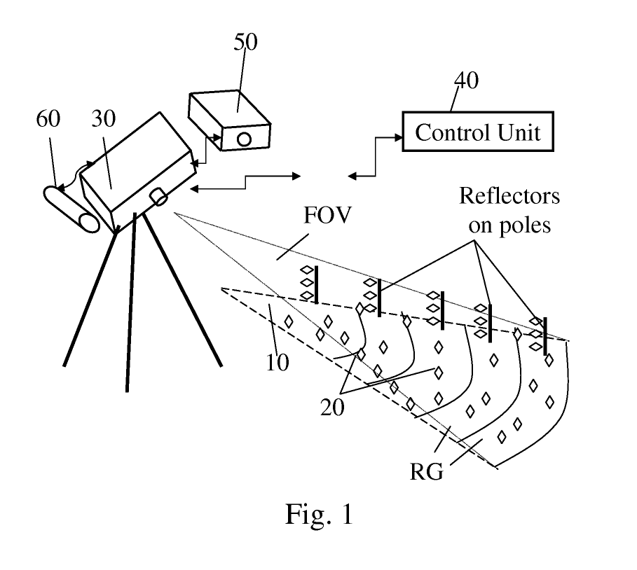

With reference to FIG. 1, the area of terrain 10 seen by a field of view FOV of an interrogator 30 may adopt various geometric shapes and sizes according to the topography of the terrain 10 and a disposition of the interrogator 30 relative to the terrain. Such geometric shapes may include a polygon, a sector of a circle, or an ellipse, or even a circle when viewed from a height above the terrain 10.

In practice, it is possible to disperse a plurality of responders, reflectors, retro-reflectors or radiation reflectors, such as corner reflectors for example, onto a selected area of terrain to form a pattern of responders. Responders may be active or passive, but low cost passive responders may be preferred.

The corner reflectors 20 may be camouflaged or packaged in a manner allowing them to pass undetected under visual inspection, but the contrary may also be practical.

The corner reflectors 20 may be dispersed manually or automatically from the ground and/or from the water, and/or from the air. Dispersion means may be disposed on land vehicles, water-going craft and airborne vehicles. Such dispersion means may include canisters or dedicated means integrated within mortar bombs, artillery shells, airdropped bombs, unmanned aerial vehicles, rockets and missiles, and other warfare delivering means.

In operation, the corner reflectors 20 may be scattered to form a ground pattern in the area 10 under surveillance. The corner reflectors 20 may be disposed as well at a height above ground level, for example mounted on a plurality of poles erected in the area 10, where at least one corner reflector is mounted on each pole.

Buildings, trees, or sides of a terrain irregularity may also serve to support a corner reflector disposed at a height above ground level. Corner reflectors 20 may be disposed in a height distribution selected alone and in combination from a group including a distribution at a same height and a distribution at different heights.

Corner reflectors 20 may be scattered at random, for example when scattered onto the area 10 from the air. Corner reflectors 20 may also be disposed at precise locations, for example when mounted at specific heights on poles.

A change in the returned signals, indicative of an intrusion, may be caused by at least one corner reflector 20 being displaced, partially obscured or completely obscured.

Detection of the pattern formed in the area 10 may be achieved by appropriate instrumentation or interrogator 30 able to send optical or electromagnetic interrogation signal(s) to the responders or corner reflectors 20 and to collect, save and store the returned signals reflected therefrom. A processor P running a computer program stored in a memory M on a processor readable medium may compare the returned signals, for example with the returned signals from the initial interrogation or to any other selected interrogation chosen as a reference interrogation and, when a change is detected therebetween, for example above a predetermined threshold, command an alarm signal to be provided.

The appropriate instrumentation, or interrogator 30, may be disposed at a level above the terrain level of the area 10 under surveillance. To enhance the field of view FOV of the interrogator, the interrogator 30 may be disposed at a height above ground level that is higher than the highest disposed corner reflector 20. Furthermore, a control unit 40, which is coupled to the interrogator 30, may be disposed away and remote from the interrogator. The control unit 40 may be configured to command the operation of the interrogator 30 and to receive and process signals returned from the area 10 under surveillance.

The interrogator 30 may be disposed on a static tripod, as shown in FIG. 1, or on a pole, column, building, hill, or mountain. However, the interrogator 30 may also be disposed on a vehicle moving on land or at sea or may be carried by a balloon or an airborne craft and may operate an appropriate computer program that considers geographical displacement.

One embodiment may include a control unit 40 commanding an interrogator 30 such as a radar for example, and a plurality of corner reflectors 20 disposed in the area 10 under surveillance.

FIG. 1 shows an area 10 of a terrain that is delimited by dashed lines and is studded with corner reflectors 20 disposed in distribution therein. In operation, the interrogator 30 may interrogate the area 10 in successive range gates RG. A control unit 40 may be coupled in wired or wireless communication with the interrogator 30. Returned signals may be processed by a processor P integrated within the interrogator 30, or be transmitted to the control unit 40 for processing thereby.

The threshold may be predetermined as being, for example, 10% of the returned signals received from the reference interrogation. Should the change in returned signals, both an increase and a decrease, exceed the threshold, the change may be indicative of an intrusion.

At least one of a radar cross section RCS and at least one voltage may be derived from the returned signals for each range gate RG and may be computed by the processor P for various angles of the field of view FOV.

An intrusion reported when one or more of the corner reflectors 20 are disposed at a height above ground level includes additional information: a minimum height of the intrusion. For example, should an animal obscure one or more corner reflectors disposed at various heights, it may be derived that the animal had a height no less than the height of the highest obscured corner reflector.

A camera 50 and a directional microphone 60, each one alone or both together, may be coupled to the radar 30 and be trained on the field of view FOV. When an intrusion is detected and to provide verification and report of the derived change in returned signals, the camera 50 and the directional microphone 60 derive images and audio signals, respectively. The images derived by the camera may be daylight images or nighttime composite images, for example infrared images. The audio signals may discriminate among various types of disturbances, for example between types of vehicles, animals and humans.

Corner reflectors 20 dispersed in an area 10 may be interrogated by various types of interrogators 30, such as optical or electromagnetic radiation-emitting means operating in association with reception and collection of information returned from the reflectors. For example, an interrogator 30 may be selected as a radar operating at a frequency of 77 GHz, having a 10-15 cm antenna aperture. The radar may be configured to tilt or to rotate or both to tilt and rotate. With a corner reflector 20 of some 10 cm, which may provide a radar cross section RCS of about 15-20 m², the 77 GHz radar interrogator 30 may operate effectively for hundreds of meters and even cover a range of up to 1,000 m. Such a range is possible since the corner reflectors 20 cooperate with the interrogation signals emitted by the radar 30. Evidently, the detection of a cooperating corner reflector 20 is relatively easy when compared to the detection of a non-cooperating object, such as an animal or a poacher wanting to avoid detection, for example.

A 77 GHz radar interrogator 30 may have a power consumption of some 100 mW. When the radar interrogator 30 includes a signal processor, the power consumption may reach 2 W, and may operate autonomously for about one week, when coupled to a power supply such as for example a 50 Ah accumulator. A power supply augmented with a solar energy production panel may also be considered.

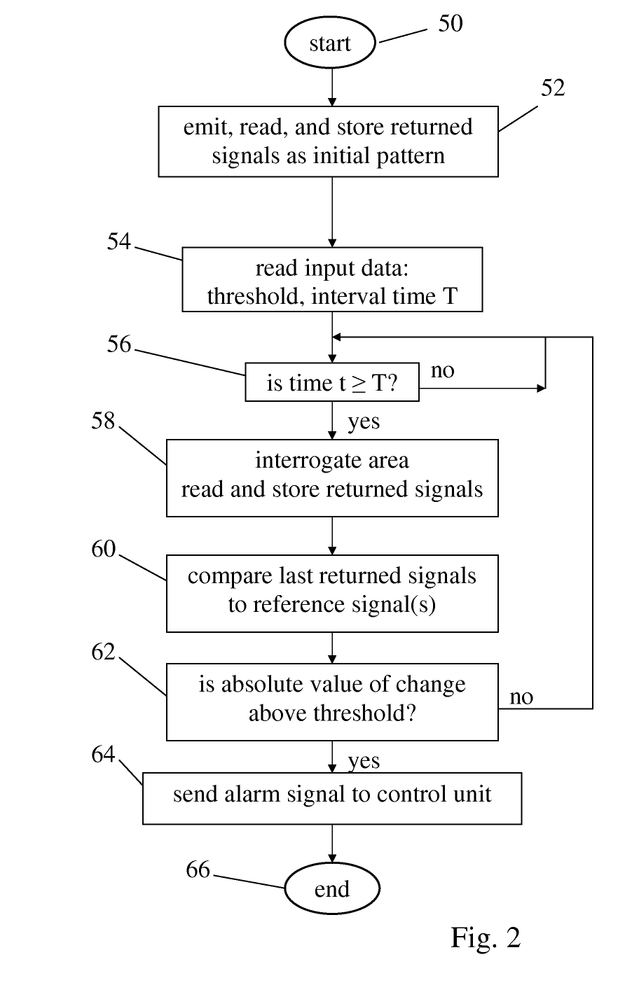

Assuming that the corner reflectors 20 are dispersed in the area 10 and that the processor P is integrated within the interrogator 30, a simple example of the operation of the system and of the method for implementing the system is illustrated in FIG. 2.

FIG. 2 depicts the process of operation of the interrogator 30, starting with step 50. In step 52, the interrogator is activated to emit and read the returned signals as the initial returned signals and to store the initially returned signals in the memory M, which is coupled to the processor P. Thereafter in step 54, the processor P reads input data that was previously loaded in memory or that is entered by an operator via the control unit 40. Such input data may include a threshold value and a predetermined time delay T separating each successive interrogation operation whereby the interrogator 30 interrogates the corner reflectors 20.

Next, in step 56, a check is made to find out if the time t measured since a previous interrogation is equal to or greater than the predetermined time delay T. Should that not be the case, control returns to step 56, but in the contrary, the process advances to step 58.

In step 58, the interrogator 30 reads and stores the returned signals in memory. As a next operation in step 60, the processor P compares the last returned signals to the initially returned signals stored as the initial signals, and/or with other previously stored signals returned as a detected and stored signals.

It is in step 62 that a check is performed to detect whether the last returned signals exceed the threshold value. If so, control returns to step 56, but otherwise, the process proceeds to step 64 that communicates an alarm signal to the control unit 40 and/or to any other desired destination via at least one wired and/or wireless communication link. The process ends in the last step 66.

The detection of a ground intrusion taking place in the present or that has taken place in the past within an area 10 is not limited to one sector of a circle as illustrated in FIG. 1. It is evident that multiple interrogators 30 may cover more than one single area that may be shaped as a sector or differently therefrom. For simplicity of description, reference will be made to a symbolic shape 10 representing the area 10 covered by one interrogator 30.

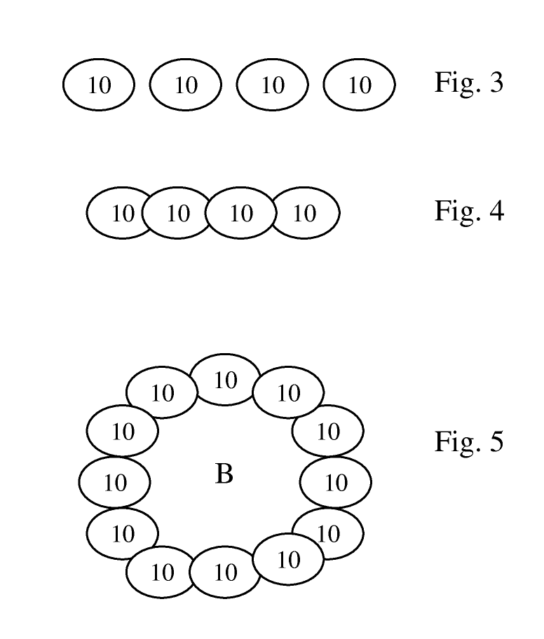

FIG. 3 presents a row of symbolic shapes 10, for example, four such shapes, shown as areas that are separated away from each other, but are interrogated by a same number of interrogators 30, not shown.

Similarly, FIG. 4 depicts a row of overlapping symbolic shapes 10 forming a chain of links, such as four, for example. Coupling together of a plurality of intrusion detection systems may be applied to form a continuous chain of terrain under surveillance.

FIG. 5 shows a protected area B encircled by a chain of overlapping symbolic shapes 10. Should an alarm signal be received from any of the interrogators 30, not shown, that are disposed in the field for discovering an intrusion in any of the areas 10, one may conclude that an intruder may have entered the protected area B. Such an intruder may be cattle, bears, boars, or any other animal. Optionally, intruders may be hunters or hitchhikers, on foot or riding one or more vehicles.

In the description and claims of the present application, each one of the verbs, “comprise” “include” and “have”, and conjugates thereof, are used to indicate that the subject or subjects of the verb are not necessarily a complete listing of members, components, elements or parts of the subject or subjects of the verb.

It will be appreciated by persons skilled in the art, that the present invention is not limited to what has been particularly shown and described hereinabove. Rather, the scope of the present invention is defined by the appended claims and includes both combinations and sub-combinations of the various features described hereinabove as well as variations and modifications thereof which would occur to persons skilled in the art upon reading the foregoing description.

### REFERENCE SIGNS LIST

10 area of terrain or area
20 corner reflectors
30 interrogator or radar
40 control unit
50 camera
60 directional microphone
M memory
FOV field of view
P processor
RCS radar cross section
RG range gate
T time delay
t time

1. A system for detecting an intrusion into an area, the system comprising:
a plurality of corner reflectors disposed in the area and distributed in a pattern,
a radar configured for interrogating the pattern of corner reflectors at successively timed apart intervals and for receiving returned signals therefrom, and
a control unit coupled to the radar for controlling the system and configured for comparing successively returned signals with signals returned from a reference interrogation to detect a change therebetween that exceeds a predetermined threshold, the change being indicative of an intrusion.

2. The system according to claim 1, wherein:
the plurality of corner reflectors is disposed in a pattern of terrain range gates.

3. The system according to claim 1, wherein:
the plurality of corner reflectors is distributed alone and in combination as selected from a group including a random pattern distribution and an ordered pattern distribution.

4. The system according to claim 1, further comprising:
at least one of both a camera and a directional microphone coupled to the control unit, and configured to derive, respectively, at least an image and at least an audio signal from the area, when an intrusion is detected.

5. The system according to claim 4, wherein:
the images derived by the camera are selected alone and in combination from a group including daylight images and nighttime images.

6. The system according to claim 5, wherein:
the nighttime images include infrared images.

7. The system according to claim 1, wherein:
the plurality of corner reflectors is disposed in a configuration selected alone and in combination from a group including disposition at ground level, disposition at a same height above ground level, and disposition at different heights above ground level.

8. The system according to claim 7, wherein:
the control unit is configured to derive a height of a highest above ground level obscured corner reflector, which height is indicative of a minimum height of the intrusion.

9. The system according to claim 1, wherein:
the change in the returned signal occurs when at least one corner reflector is detected in a disposition selected alone and in combination from a group including an obscured corner reflector and a displaced corner reflector.

10. The system according to claim 1, wherein:
the plurality of corner reflectors is disposed in the area by means selected from a group including ground based means, seagoing means, and airborne means.

11. The system according to claim 1, wherein:
the plurality of corner reflectors is selected alone and in combination from a group including camouflaged corner reflectors and corner reflectors that are packaged to enhance prevention of detection by visual surveillance of the area.

12. The system according to claim 1, wherein:
the radar is disposed at a height above ground level.

13. The system according to claim 1, wherein:
the radar is disposed remote from the control unit.

14. A method for detecting intrusion in an area, the method comprising the steps of:
distributing a plurality of corner reflectors in the area in a pattern, including a pattern of terrain range gates,
operating a radar to interrogate the plurality of corner reflectors by emitting and receiving returned signals therefrom at successively timed apart intervals, and
providing a control unit (40) coupled to the radar and operating the control unit to compare successively returned signals received by the radar from the pattern to a reference returned signal, to detect a change therebetween that exceeds a predetermined threshold, the change being indicative of an intrusion.

15. The method according to claim 14, further comprising the step of:
deriving a radar cross section and a voltage from returned signals received from each one of the terrain range gates.

16. The method according to claim 14, further comprising the step of:
providing enhanced detection of an intrusion in the area by deriving at least one of both at least an image and at lest an audio signal from the area.

17. The method according to claim 14, further comprising the step of:
detecting a change in the returned signals in response to at least one of the corner reflectors being detected in a disposition selected alone and in combination from a group including an obscured corner reflector and a displaced corner reflector.

18. The method according to claim 14, further comprising the steps of:
distributing at least one corner reflector at a specific height above ground level, and
detecting a change in the returned signals in response to the at least one corner reflector being obscured by an intrusion, the specific height being indicative of a minimum height of the intrusion.

19. The method according to claim 14, further comprising the step of:
triggering an alarm signal upon detecting an intrusion.

20. The method according to claim 14, further comprising the step of:
coupling together a plurality of intrusion detection systems to form a chain of terrain under surveillance.
